(19) United States
(12) Patent Application Publication
(10) Pub. No.: US 2018/0252119 A1
(43) Pub. Date: Sep. 6, 2018

(54) TURBINE ENGINES, ENGINE STRUCTURES, AND METHODS OF FORMING ENGINE STRUCTURES WITH IMPROVED INTERLAYER BONDING

(71) Applicant: HONEYWELL INTERNATIONAL INC., Morris Plains, NJ (US)

(72) Inventors: Terence Whalen, Morristown, NJ (US); Reza Oboodi, Morris Plains, NJ (US); James Piascik, Randolph, NJ (US); Don Martin Olson, Dover, NJ (US); Natalie Kruk, Phoenix, AZ (US)

(73) Assignee: HONEYWELL INTERNATIONAL INC., Morris Plains, NJ (US)

(21) Appl. No.: 15/446,867

(22) Filed: Mar. 1, 2017

(51) Int. Cl. F01D 25/00; C23C 4/134; C23C 4/04

(52) U.S. Cl. CPC F01D 25/005; C23C 4/134; C23C 4/04; F05D 2220/32; F05D 2300/2283; F05D 2230/10; F05D 2230/42; F05D 2300/222; F05D 2300/2102; F05D 2230/22

(57) ABSTRACT

Engine structures and methods of forming the engine structures are provided herein. In an embodiment, an engine structure includes a silicon-based ceramic-containing substrate having an in-tolerance surface and one or more barrier layers disposed on the in-tolerance surface of the ceramic-containing substrate. The ceramic-containing substrate includes a bulk zone and a gradient zone. The bulk zone includes a first bulk material. The gradient zone includes the first bulk material and a second material that is different from the first bulk material. The gradient zone has a gradient of increasing concentration of the second material from the bulk zone to the in-tolerance surface of the ceramic-containing substrate.

### STATEMENT REGARDING FEDERALLY SPONSORED RESEARCH OR DEVELOPMENT

This invention was made with Government support under EG-002745/NWA 7006364914 awarded by the U.S. Army. The Government has certain rights in this invention.

### TECHNICAL FIELD

The technical field generally relates to turbine engines, engine structures, and methods of forming engine structures with improved interlayer bonding between layers in the engine structures. More particularly, the technical field relates to engine structures and methods of forming engine structures with improved bonding between a substrate and one or more barrier layers that are disposed over the substrate in the engine structures, and turbine engines that include the engine structures.

### BACKGROUND

Aircraft gas turbine engines are often exposed to extreme conditions during operation that cause degradation or compromise of structures therein, resulting in required maintenance or replacement of various parts of the engines. Maximized engine efficiency is continuously sought, with higher operating temperatures corresponding to higher efficiency. Therefore, there is a constant endeavor to improve capabilities of the engine structures to withstand high operating temperatures for extended periods of time. Unfortunately, many conventional materials that are suitable for the engine structures based upon mechanical and manufacturability properties thereof, such as super-alloys, monolithic ceramics, and ceramic matrix composites, are prone to degradation under the high operating temperatures and other environmental factors. To impede degradation of the engine structures, the engine structures may include various coatings formed over the substrates. For example, the engine structures may include an environmental barrier coating (EBC) to protect the engine structures from oxidation and corrosion due to exposure to oxygen and water vapor, as well as other airborne contaminants such as calcia-mangesia-alumina-silicate (CMAS). The engine structures may also include a thermal barrier coating (TBC), independent from the EBC, to effectively insulate and minimize thermal impact on the engine structures due to temperature cycling.

Conventional manufacture of the engine structures generally involves formation of the TBC and EBC after machining the engine structure to a desired shape. Referring to FIG. 1, silicon-based ceramic substrates are generally formed through sintering processes whereby silicon-based powder and a sintering aid are shaped in a mold by batch powder addition to a desired thickness (as illustrated by the progression of heights shown for the powder layer 20). The powder is of substantially uniform composition during the process, with relatively low amounts of sintering aid (e.g., less than about 5 weight % based on the total weight of the powder composition). The powder in the mold is then cold pressed (green body formation) followed by fusion of the powder. In one process, fusion of the powder proceeds with glass encapsulation of the compressed powder. Once the glass is in place, sintering proceeds with high temperature isostatic processing to effectuate fusion of the powder and formation of a sintered substrate. In another process, pressureless sintering is employed whereby glass encapsulation is unnecessary to form the sintered substrate. In another process, in the case of silicon-based powders, a polymer infiltration and pyrolysis step may be employed to fuse the powder and form the sintered substrate. The sintered substrate may be machined and annealed to meet desired shape tolerance parameters for the particular part and thereby form an in-tolerance surface, or the sintered substrate may be finished with a net shape to have an in-tolerance surface, resulting in the sintered substrate 14 as shown in FIG. 2. The EBCs and the TBCs must be formed after sintering and machining of the substrate to maintain desired dimensional tolerances in the engine structure and also because machining the EBCs and TBCs could compromise complete surface coverage of those silicon-based substrates in the engine structures. Further, the EBCs and TBCs are formed via different processes than those employed during sintering, such as plasma spray and electron beam physical vapor deposition, and such processes are not compatible with steps during sintering. However, suitable materials for the EBCs and the TBCs often exhibit imperfect bonding to the materials of the sintered substrate, thereby necessitating a bond layer to adequately bond the EBC and the TBC coating stack to the sintered substrate. For example, referring to FIG. 2, a conventional engine structure 10 is illustrated and shows a bond layer 12 disposed between a sintered and machined substrate 14 and the barrier layer 16. The bond layer 12, itself, is often prone to failure under the extreme operating conditions of the turbine engines, resulting in delamination or intrusion of CMAS and high temperature fluids (including gases and liquefied CMAS) into the engine structures. Suitable materials for the bond layer 12 may depend upon particular chemistry of the substrate 14 and the immediately overlying barrier layer 16. For example, conventional materials for the bond layer 12 may include a MCrAlY alloy or an intermetallic aluminide, with techniques for forming bond layers from those compositions generally known. A thermally grown oxide (TGO) layer 18 is generally formed as a consequence of conditions that are generally employed to form the bond layer 12 and the barrier layer 16. While the TGO layer 18 may provide oxidation resistance to the bond layer 12 and provides a bonding surface for the barrier layer 16, the bond layer 12 is still often subject to failure over time with growth of the TGO. TGO growth kinetics are dependent on time at temperature. For example, yttria-stabilized zirconia (YSZ) TBCs formed by electron beam plasma vapor deposition (EB-PVD) will form an alumina-based TGO that causes spallation of the TBC once it reaches a critical thickness. Thus, with increasing temperature demands on the coated component it is desirable to apply protective coatings that can meet the spallation life requirements.

Accordingly, it is desirable to provide engine structures and methods of forming the engine structures with improved interlayer bonding between a silicon-based ceramic-containing substrate and one or more barrier layers that are disposed on the substrate, optionally in the absence of a bond layer disposed between the substrate and a barrier layer disposed directly thereon. Furthermore, other desirable features and characteristics of the present invention will become apparent from the subsequent detailed description of the invention and the appended claims, taken in conjunction with the accompanying drawings and this background of the invention.

### BRIEF SUMMARY

Engine structures and methods of forming the engine structures are provided herein. In an embodiment, an engine structure includes a silicon-based ceramic-containing substrate having an in-tolerance surface and one or more barrier layers disposed on the in-tolerance surface of the ceramic-containing substrate. The ceramic-containing substrate includes a bulk zone and a gradient zone. The bulk zone includes a first bulk material. The gradient zone includes the first bulk material and a second material that is different from the first bulk material. The gradient zone has a gradient of increasing concentration of the second material from the bulk zone to the in-tolerance surface of the ceramic-containing substrate.

In another embodiment, an engine structure includes a silicon-based ceramic-containing substrate including a bulk zone and a gradient zone. The bulk zone includes a first bulk material and the gradient zone includes the first bulk material and a second material that is different from the first bulk material. The gradient zone has a gradient of increasing concentration of the second material from the bulk zone to the in-tolerance surface of the ceramic-containing substrate. One or more barrier layers is disposed on the surface of the ceramic-containing substrate and the engine structure is free from a bond layer between the ceramic-containing substrate and a barrier layer disposed directly on the substrate.

In another embodiment, a method of forming an engine structure includes sintering silicon-based ceramic particles to form an intermediate structure. The intermediate structure includes fused particles with atoms in the fused particles diffused across boundaries of the particles. The intermediate structure is machined to form a silicon-based ceramic-containing substrate that has a machined surface. The silicon-based ceramic-containing substrate includes a bulk zone and a gradient zone. The bulk zone includes a first bulk material and the gradient zone includes the first bulk material and a second material that is different from the first bulk material. The gradient zone has a gradient of increasing concentration of the second material from the bulk zone to the in-tolerance surface of the ceramic-containing substrate. One or more barrier layers is formed on the machined surface of the substrate.

### BRIEF DESCRIPTION OF THE DRAWINGS

The various embodiments will hereinafter be described in conjunction with the following drawing figures, wherein like numerals denote like elements, and wherein:

FIG. 1 is a schematic side view of a method of forming a conventional engine structure;

FIG. 2 is a schematic cross-sectional side view of a portion of a conventional engine structure of the prior art including a substrate, a bond layer, and a barrier layer disposed over the bond layer;

FIG. 3 is a schematic cross-sectional side view of a portion of a turbine engine including an engine structure;

FIG. 4a is a schematic cross-sectional side view of an engine structure in accordance with an exemplary embodiment;

FIG. 4b is a magnified cross-sectional view of substrate microstructure of the engine structure of FIG. 4a;

FIG. 5 is a schematic side view of a method of forming an engine structure of FIG. 3;

FIG. 6 is a schematic cross-sectional side view of an engine structure in accordance with another exemplary embodiment; and

FIGS. 7-9 are schematic cross-sectional side views of a method of forming an engine structure of FIG. 6.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

Engine structures, and methods of forming engine structures are provided that exhibit improved interlayer bonding between a silicon-based ceramic-containing substrate and one or more barrier layers that are disposed on the substrate. The substrate has a bulk zone that includes a first bulk material, e.g., silicon-based material such as silicon nitride, silicon carbide, or the like, and a gradient zone that includes the first bulk material and a second material. The gradient zone has a gradient of increasing concentration of the second material from the bulk zone to the surface of the substrate. The second material is different from the first bulk material and may be chosen to provide a more compatible surface of the substrate for bonding with the subsequently-deposited barrier materials. In this regard, improved interlayer bonding may be achieved between the silicon-based ceramic-containing substrate and one or more barrier layers that are disposed on the substrate, even in the absence of a bond layer disposed between the substrate and a barrier layer.

As referred to herein, “silicon-based” means that the bulk zone has a majority of silicon-containing compounds, by weight. “Ceramic”, as used herein, refers to a nonmetallic solid material having ionic and covalent bonds (i.e., substantially free of metallic bonds) such as, e.g., nitrides and carbides. The “substrate”, as referred to herein, is a structure formed after any machining (e.g., milling, drilling, or other mechanical material removal techniques), prior to surface deposition of barrier materials or materials that are employed to facilitate bonding of the barrier materials to the substrate. In this regard, in embodiments, the substrate includes an in-tolerance surface. The in-tolerance surface may be attained after machining or the substrate may be a net shaped part that does not require machining to meet the desired dimensional tolerances. “Gradient”, as referred to herein, is a distribution of the second material and the first bulk material from a higher concentration of the second material proximal to the surface of the substrate to a lower concentration of the second material into the substrate from the surface, toward the bulk zone, optionally with up to about 100 weight % of the second material at the surface of the substrate.

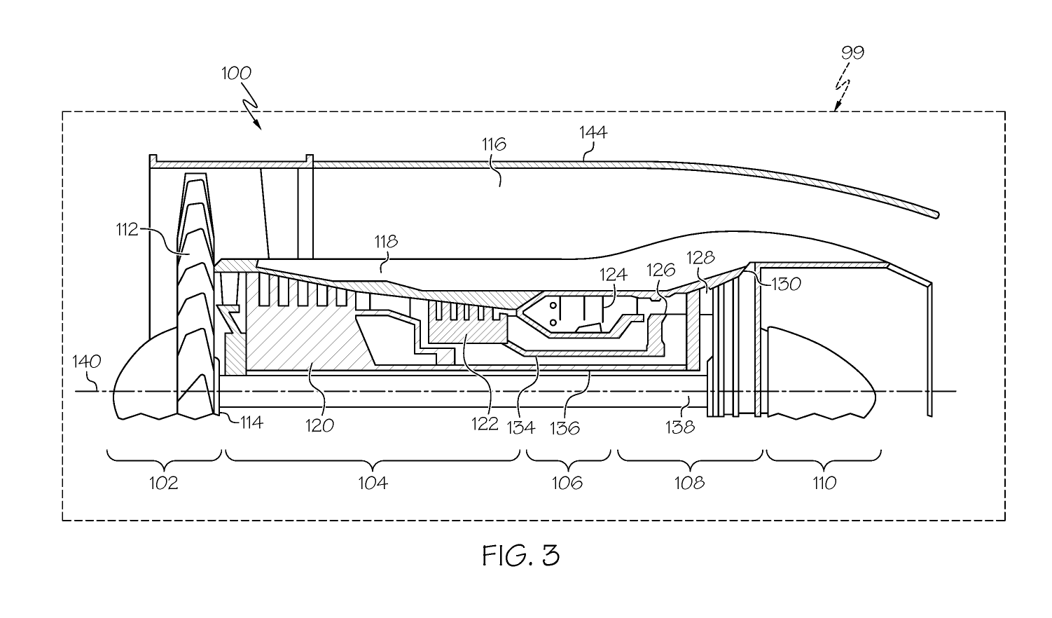

With reference to FIG. 3, a partial, cross-sectional view of an exemplary turbine engine 100 is shown with the remaining portion of the turbine engine 100 being axi-symmetric about a longitudinal axis 140, which also includes an axis of rotation for the gas turbine engine 100. In the depicted embodiment, the turbine engine 100 is an annular multi-spool turbofan gas turbine jet engine 100 within an aircraft 99, although other arrangements and uses may be provided. Components of the gas turbine engine 100 may be, for example, also found in an auxiliary power unit (“APU”).

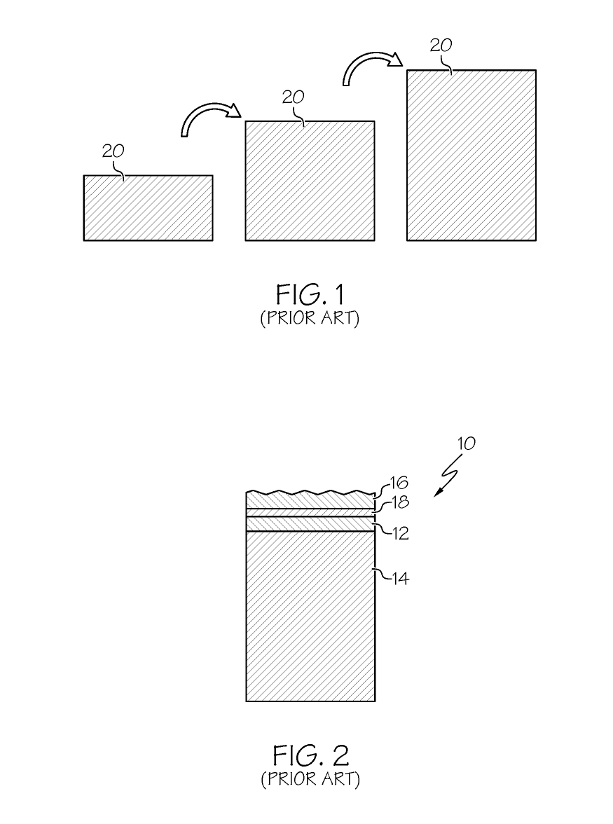

In this example, the turbine engine 100 includes a fan section 102, a compressor section 104, a combustor section 106, a turbine section 108, and an exhaust section 110. The fan section 102 includes a fan 112 mounted on a rotor 114 that draws air into the gas turbine engine 100 and accelerates it. A fraction of the accelerated air exhausted from the fan 112 is directed through an outer (or first) bypass duct 116 and the remaining fraction of air exhausted from the fan 112 is directed into the compressor section 104. The outer bypass duct 116 is generally defined by an inner casing 118 and an outer casing 144. In the embodiment of FIG. 1, the compressor section 104 includes an intermediate pressure compressor 120 and a high pressure compressor 122. However, in other embodiments, the number of compressors in the compressor section 104 may vary. In the depicted embodiment, the intermediate pressure compressor 120 and the high pressure compressor 122 sequentially raise the pressure of the air and direct a majority of the high pressure air into the combustor section 106. A fraction of the compressed air bypasses the combustor section 106 and is used to cool, among other components, turbine blades in the turbine section 108 via an inner bypass duct.

In the embodiment of FIG. 1, in the combustor section 106, which includes a combustion chamber 124, the high pressure air is mixed with fuel and combusted. The high-temperature combusted air is then directed into the turbine section 108. In this example, the turbine section 108 includes three turbines disposed in axial flow series, namely, a high pressure turbine 126, an intermediate pressure turbine 128, and a low pressure turbine 130. However, it will be appreciated that the number of turbines, and/or the configurations thereof, may vary. In this embodiment, the high-temperature combusted air from the combustor section 106 expands through and rotates each turbine 126, 128, and 130. As the turbines 126, 128, and 130 rotate, each drives equipment in the gas turbine engine 100 via concentrically disposed shafts or spools. In one example, the high pressure turbine 126 drives the high pressure compressor 122 via a high pressure shaft 134, the intermediate pressure turbine 128 drives the intermediate pressure compressor 120 via an intermediate pressure shaft 136, and the low pressure turbine 130 drives the fan 112 via a low pressure shaft 138.

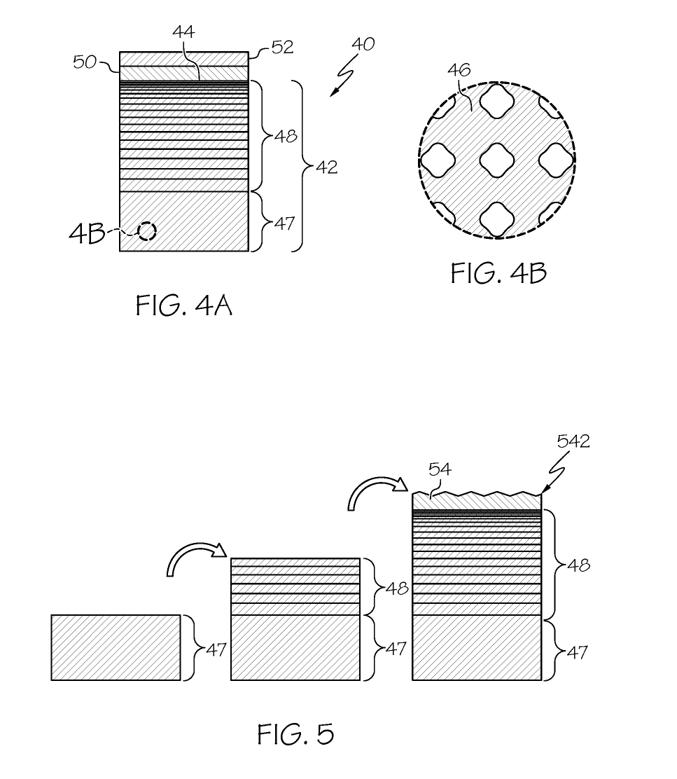

An exemplary embodiment of an engine structure 40 and a method of forming the engine structure will now be described with reference to FIGS. 4 and 5. The engine structure 40 may be, for example, any of the structures described above in reference to the turbine engine shown in FIG. 3. In embodiments, the engine structure 40 is exposed to elevated operating temperature and airborne particles during operation of the turbine engine 10, such as a rotating component of the turbine engine 10, although it is to be appreciated that the engine structure 40 may also or alternatively be disposed on a non-rotating component of the turbine engine 10, such as a turbine nozzle. However, the particular location and application for the engine structure 40 as described herein within a turbine engine is not particularly limited and can be any structure of the turbine engine 10 that is exposed to elevated operating temperature. “Elevated operating temperature” may be, for example, a temperature of at least about 1000° C., such as at least about 1150° C., or such as at least 1200° C.

Referring to FIG. 4a, the engine structure 40 includes a silicon-based ceramic-containing substrate 42. In embodiments, the substrate 42 includes ceramic materials in an amount of at least 90 weight %, such as from about 90 to about 100 weight %, or such as about 100 weight %, based on the total weight of the substrate 42. In other embodiments and as described below, the substrate 42 further includes a glass encapsulation (not shown in FIG. 4a) that remains after sintering and machining, and the glass encapsulation does not factor into the amount ranges set forth above. As alluded to above, the substrate 42 is the structure having an in-tolerance surface formed after any machining, e.g., through mechanical material removal such as milling, drilling, and the like, prior to subsequent barrier material deposition. Thus, in embodiments, the substrate 42 has a machined surface 44 although it is to be appreciated that the surface 44 may be an in-tolerance surface in the absence of machining depending upon the particular processes by which the substrate 42 is formed and further depending upon desired tolerances for the substrate 42.

Referring momentarily to FIG. 4b, the ceramic-containing substrate 42 includes fused particles 46 with atoms in the fused particles 46 diffused across the boundaries of the particles 46. The fused particles 46 may be obtained as a result of sintering, as described in further detail below in regards to an exemplary method of forming the engine structure 40. Individual particles 46 may include the respective first bulk material, second material, and the sintering aid, with fusion of the particles 46 resulting in diffusion of atoms of the respective materials into particles 46 primarily having the other materials in accordance with conventional principles of sintering. In an embodiment, the in-tolerance surface 44 of the ceramic-containing substrate 42 includes the fused particles 46.

Referring again to FIGS. 4a and 5, the ceramic-containing substrate 42 includes a bulk zone 47 that includes a first bulk material and a gradient zone 48 that includes the first bulk material and a second material that is different from the first bulk material. In embodiments, the first bulk material is a monolithic silicon-based ceramic such as silicon nitride or silicon carbide. The second material is different from the first bulk material and is chosen to provide improved bond adhesion between the substrate 42 and a barrier layer 50 that is disposed immediately thereon. More specifically, the first bulk material and the second material are chosen from different groups of compounds with no overlap between the groups of compounds. In an embodiment, the second material is an environmental barrier coat material, i.e., a material that is conventionally employed in environmental barrier coat layers. Suitable second materials include oxides such as, for example, silicon and/or rare earth-containing oxides. For example, in embodiments, the second material is an oxide that includes at least one of a rare earth element. Specific examples of suitable second materials include those chosen from Yb₂O₃, Y₂O₃, SiO₂, Y₂Si₂O₇, and/or Yb₂SiO₇, such as those chosen from Yb₂O₃, Y₂Si₂O₇, and/or Yb₂SiO₇.

In embodiments and as shown in FIG. 4a, the gradient zone 48 has a gradient of increasing concentration of the second material, relative to the first bulk material, from the bulk zone 47 of the ceramic-containing substrate 42 to the in-tolerance surface 44 of the ceramic-containing substrate 42. In embodiments, the gradient zone 48 is disposed from the surface 44 of the substrate 42 to at least 1 mm, such as to at least 2 mm, or such as to at least 3 mm into the substrate 42 from the surface 44 of the substrate 42. In embodiments, a concentration of the second material in the gradient zone 48 at the surface 44 of the substrate 42 is greater than 10 weight %, such as from about 20 to about 100 weight %, or such as about 100 weight % based on the total weight of a surface layer 1 micron deep into the substrate 42. In further embodiments, the above-referenced surface concentrations of the second material exist within a surface layer 10 microns deep into the substrate 42, with the gradient zone 48 disposed from the surface 44 of the substrate 42 to a depth of from about 2 mm to about 3 mm into the substrate from the surface 44 of the substrate 42.

In embodiments, the bulk zone 47 of the substrate 42 is identified by having a substantially uniform composition, i.e., no identifiable gradient. In embodiments, the bulk zone 47 begins at depths of at least 1 mm, such as at least about 2 mm, or such as at least about 3 mm into the substrate 42 from the surface 44. In the bulk zone 47, the ceramic-containing substrate 42 includes at least 90 weight % of the first bulk material, such as at least 96 weight % of the first bulk material, with sintering aid and/or trace amounts of the second material contributing to the balance of the bulk zone 47. As such, in embodiments, the sintering aid may be present in an amount of up to about 10 weight %, such as from about 0.1 to about 4 weight %, based upon the total weight of ceramic-containing substrate 42 outside of the gradient zone 48. Trace amounts of the second material, as referred to herein, include amounts less than about 0.1 weight % of the second material. Conventional sintering aid materials may be employed for the sintering aid such as, e.g., yttrium oxide (Y₂O₃), alumina, magnesium oxide, titanium dioxide, or any combination thereof.

As alluded to above, one or more barrier layers 50, 52 are disposed on the in-tolerance surface 44 of the ceramic-containing substrate 42. For example, as shown in FIG. 4a, the barrier layer 50 is an environmental barrier coat layer 50 and is disposed directly on the ceramic-containing substrate 42. The environmental barrier coat layer 50 may include materials such as those described above for the second material, with the environmental barrier coat layer 50 clearly distinct from the substrate 42 due to the environmental barrier coat layer 50 being formed after formation of the substrate 42 and, in some embodiments, machining to form the machined surface 44 of the substrate 42. However, it is to be appreciated that in embodiments, thickness of the second material in the gradient zone 48 may obviate the need for a separate environmental barrier coat layer such as in embodiments in which the in-tolerance surface 44 has about 100 weight % of the second material. In such embodiments, the gradient zone 48 may have a subregion (not shown) having 100 weight % of the second material, with the subregion having a substantially uniform composition. In this regard, the subregion of the gradient zone 48 may form an intrinsic environmental barrier coat, thereby obviating any need for the environmental barrier coat layer 50. In embodiments, the environmental barrier coat layer 50 has a thickness of from about 1 to about 1000 microns, such as from about 25 to about 250 microns.

In embodiments and as shown in FIG. 4a, a thermal barrier coat layer 52 is disposed over the environmental barrier coat layer 50. Suitable materials for the thermal barrier coat layer 52 include yttria-stabilized zirconia, rare-earth zirconates, alkaline earth metal zirconates. The thermal barrier coat layer 52 may have a thickness of from about 1 to about 1000 microns, such as from about 25 to about 250 microns.

As alluded to above, due to the gradient zone 48 in the substrate 42, the engine structure 40 may be free from a bond layer between the substrate 42 and the barrier layer 50 or 52 that is disposed directly thereon while still achieving adequate bond adhesion between the substrate 42 and the barrier layer 50 or 52. Thus, in such embodiments, the barrier layer 50 or 52 is disposed directly on the in-tolerance surface 44 of the substrate 42.

A method of forming the engine structure 40 as shown in FIG. 4a will now be described with reference to FIG. 5. In accordance with an exemplary method, silicon-based ceramic particles are sintered to form an intermediate structure 542 that includes fused particles with atoms in the fused particles diffused across the boundaries of the particles (as shown in FIG. 4b). More specifically, particles including the first bulk material, which includes the monolithic silicon-based ceramic, along with powdered sintering aid are progressively deposited in a mold (not shown) to build up a desired thickness, thereby forming the bulk zone 47. The material in the bulk zone 47 is of substantially uniform composition during deposition, with relatively low amounts of sintering aid (e.g., less than about 10 weight % based on the total weight of the composition in the bulk zone 47). The gradient zone 48 is then formed including particles of the first bulk material and particles the second material by continuing to deposit particles of the first bulk material and by adding particles of the second material. An amount of the particles including the second material is gradually increased relative to the particles including first bulk material to form the gradient zone 48 having a gradient of increasing concentration of the second material from the bulk zone 47 of the silicon-based ceramic-containing substrate 42 to the surface 44, with the closer spacing of horizontal striations in FIG. 5 representing greater concentrations of the second material in the gradient zone 48 to illustrate the gradient (not separate layers). The particulate composition in the mold is then cold pressed (green body formation) in accordance with conventional techniques. In embodiments, sintering may be effectuated through high temperature or “hot” isostatic processing (HIP) by forming a glass encapsulation 54 over the compressed particulate composition in the mold and applying elevated temperatures and isostatic pressure to the glass encapsulation 54, thereby effectuating fusion of the particles and formation of the intermediate structure 542. In other embodiments, sintering may be effectuated through conventional pressureless sintering processes.

After sintering, the intermediate structure 542 may be machined to form the silicon-based ceramic-containing substrate 42 as shown in FIG. 4a. In embodiments and as shown in FIG. 4a, the fused particles of the intermediate structure 542 are machined to form the in-tolerance surface 44 as a machined surface 44, i.e., the glass encapsulation 54 is completely removed to expose the fused particles of the gradient zone 48. As such, in this embodiment, the gradient zone 48 is exposed at the machined surface 44 for bonding with the subsequently-formed barrier layer 50. The barrier layer(s) 50, 52 are then formed over the machined surface 44 through conventional techniques. For example, in embodiments, the barrier layer(s) may be formed by plasma-assisted spraying the barrier material directly onto the machined surface 44 of the substrate 42 to form the barrier layer 50 or 52 on the machined surface 44 of the substrate 42.

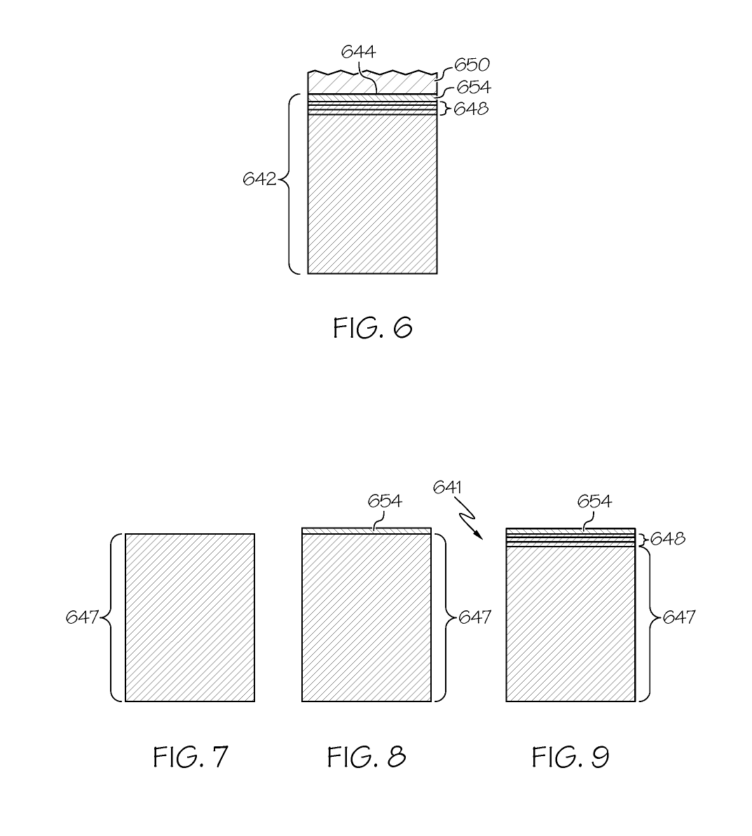

In another embodiment and as shown in FIG. 6, a gradient zone 648 is formed by introducing the second material into a substrate 642 through a glass encapsulation 654 that includes the second material, with the glass encapsulation 54 employed during HIP. In particular, in this embodiment and as shown in FIG. 7, particles including the first bulk material along with powdered sintering aid are deposited in a mold (not shown) to a desired thickness, thereby forming the bulk zone 647. The particulate composition in the mold is then cold pressed (green body formation) in accordance with conventional techniques followed by forming the glass encapsulation 654 over the compressed particulate composition in the mold, as illustrated in FIG. 8. HIP is then conducted to form an intermediate structure 641, as shown in FIG. 9. Because diffusion of the second material through the intermediate structure 641 occurs more readily during sintering than through post-sintering formation of the barrier layer(s) on the substrate 642, the second material readily diffuses from the glass encapsulation 654 into the bulk zone 647, thereby forming a gradient zone 648 during HIP as shown in FIG. 9. As such, in this embodiment, while the gradient zone 648 may still be formed by addition of particles including the second material to the first bulk material during particle deposition and prior to HIP, the glass encapsulation 54 provides at least some of the second material. Also in this embodiment, at least a portion of the glass encapsulation 654 may remain in the substrate 642 after optional machining the intermediate structure 641, as shown in FIG. 6, with an in-tolerance surface 644 of the substrate 642 being a machined surface 644 of the glass encapsulation 654. One or more barrier layer(s) 650 may be formed directly on the machined surface 644 after machining as described above. However, it is to be appreciated that in other embodiments, the in-tolerance surface 644 of the glass encapsulation may be achieved in the absence of machining or material removal depending upon the process by which the substrate 642 is formed and further depending upon desired tolerances for the substrate 642

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An engine structure comprising:
a silicon-based ceramic-containing substrate having an in-tolerance surface, wherein the ceramic-containing substrate comprises:
a bulk zone including a first bulk material; and
a gradient zone including the first bulk material and a second material different from the first bulk material, wherein the gradient zone has a gradient of increasing concentration of the second material from the bulk zone to the in-tolerance surface of the ceramic-containing substrate; and
one or more barrier layers disposed on the in-tolerance surface of the ceramic-containing substrate.

2. The engine structure of claim 1, wherein the ceramic-containing substrate comprises fused particles with atoms in the fused particles diffused across boundaries of the particles.

3. The engine structure of claim 2, wherein in-tolerance surface of the ceramic-containing substrate is a machined surface.

4. The engine structure of claim 3, wherein the machined surface of the ceramic-containing substrate comprises the fused particles.

5. The engine structure of claim 2, wherein the ceramic-containing substrate further comprises a glass encapsulation formed prior to high temperature isostatic processing, and wherein the in-tolerance surface is a surface of the glass encapsulation.

6. The engine structure of claim 1, wherein the first bulk material comprises silicon nitride.

7. The engine structure of claim 1, wherein the second material is an environmental barrier coat material.

8. The engine structure of claim 7, wherein the second material is an oxide comprising at least one of a rare earth element or silicon.

9. The engine structure of claim 8, wherein the second material is chosen from Yb₂O₃, Y₂O₃, SiO₂, Y₂Si₂O₇, and/or Yb₂SiO₇.

10. The engine structure of claim 7, wherein the second material is present within fused particles of the substrate.

11. The engine structure of claim 1, wherein the one or more barrier layers comprises an environmental barrier coat layer disposed directly on the ceramic-containing substrate.

12. The engine structure of claim 11, wherein the one or more barrier layers further comprises a thermal barrier coat layer disposed over the environmental barrier coat layer.

13. The engine structure of claim 1, wherein the gradient zone is disposed from the in-tolerance surface of the substrate to at least 1 mm into the substrate from the in-tolerance surface of the substrate.

14. The engine structure of claim 1, wherein the engine structure is free from a bond layer between the substrate and a barrier layer disposed directly thereon.

15. A turbine engine including the engine structure of claim 1.

16. An engine structure comprising:
a silicon-based ceramic-containing substrate, wherein the ceramic-containing substrate comprises:
a bulk zone including a first bulk material; and
a gradient zone including the first bulk material and a second material different from the first bulk material, wherein the gradient zone has a gradient of increasing concentration of the second material from the bulk zone to the in-tolerance surface of the ceramic-containing substrate; and
one or more barrier layers disposed on the surface of the ceramic-containing substrate;
wherein the engine structure is free from a bond layer between the ceramic-containing substrate and a barrier layer disposed directly thereon.

17. A method of forming an engine structure, wherein the method comprises:
sintering silicon-based ceramic particles to form an intermediate structure comprising fused particles with atoms in the fused particles diffused across boundaries of the particles;
machining the intermediate structure to form a silicon-based ceramic-containing substrate having a machined surface, wherein the silicon-based ceramic-containing substrate comprises:
a bulk zone including a first bulk material; and
a gradient zone including the first bulk material and a second material different from the first bulk material, wherein the gradient zone has a gradient of increasing concentration of the second material from the bulk zone to the in-tolerance surface of the ceramic-containing substrate; and
forming one or more barrier layers on the machined surface of the substrate.

18. The method of claim 17, wherein sintering further comprises forming a glass encapsulation over the silicon-based ceramic particles and high temperature isostatic processing after forming the glass encapsulation to form the intermediate structure.

19. The method of claim 18, wherein machining the intermediate structure comprises machining the glass encapsulation, and wherein the machined surface is a surface of the glass encapsulation.

20. The method of claim 17, wherein machining the intermediate structure comprises machining the fused particles of the intermediate structure.
